(19) United States
(12) Patent Application Publication
(10) Pub. No.: US 2010/0004861 A1
(43) Pub. Date: Jan. 7, 2010

(54) Obstacle detecting apparatus and method

(75) Inventors: Dong-ryeol Park, Hwaseong-si (KR); Yeon-ho Kim, Yongin-si (KR); Joon-kee Cho, Yongin-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/318,587

(22) Filed: Dec. 31, 2008

(30) Foreign Application Priority Data
Jul. 2, 2008 (KR) 10-2008-0063884

(51) Int. Cl. G06G 7/78

(52) U.S. Cl. 701/301; 901/1

(57) ABSTRACT

An obstacle detecting apparatus and a method thereof, which are usable in an autonomous moving robot, are provided. The obstacle detecting apparatus extracts at least one plane from measured range data, extracts at least one intersection point and at least one intersection line using at least one plane, and extracts matching data neighboring at least one intersection point and at least one intersection line from the range data. The matching data is extracted by reflecting uncertainties of the intersection point and the intersection line extracted from the measured range data. Matching is performed between the extracted matching data and model data, and an obstruction is detected by using the matching result.

### CROSS-REFERENCE TO RELATED APPLICATIONS

This application claims the benefit under 35 U.S.C. § 119(a) of Korean Patent Application No. 10-2008-0063884, filed on Jul. 2, 2008, the disclosure of which is incorporated herein in its entirety by reference.

### BACKGROUND

1. Field

One or more embodiments discussed in the following description relate to an obstacle detecting apparatus and a method thereof, and more particularly, to an obstacle detecting apparatus and method thereof to be used for an autonomous mobile robot.

2. Description of the Related Art

With the development of new technologies in optics and electronics, cheaper and more accurate laser scanning systems are available. By such laser scanning systems, depth information can be achieved directly from an object, making range image analysis easier, and thus the applications of the laser scanning system can expand in various fields. A range image consists of groups of three dimensional structural data points, and depicts a free-shaped surface from various points of view.

Registration of a range image has been one of widely well-known issues related to a machine vision. Various forms of solutions such as scatter matrix, geometric histogram, iterative closest point (ICP), graph matching, external point, exploration of range base, and an interactive method have been suggested to resolve the registration issue. The registration technique is applied to a variety of fields for object recognition, movement estimation, scene understanding, and robot autonomous driving.

An iterative closest point (ICP) algorithm has drawn more attention from a machine vision field. The ICP algorithm has relatively higher accuracy, but it takes more time to perform matching between data when there is a large amount of data to be matched, for example, in the case of 3α plane matching. Also, since the ICP algorithm minimizes all errors of points between range data and model data, matching performance may deteriorate when a background is detected in an image.

### SUMMARY

Accordingly, in one aspect, there is provided a method and apparatus for efficiently extracting points to be used for prompt and accurate data matching between three dimensional model data and measured range data.

According to another aspect, there is provided a obstacle detecting apparatus including a model data managing unit which stores and manages model data representing a three dimensional (3α) environment, a range data measuring unit which measures range data for an obstacle, a matching data extracting unit which extracts at least one plane based on the measured range data, extracts at least one intersection point and at least one intersection line by use of the at least one plane and extracts matching data neighboring the at least one intersection point and at least one intersection line, a matching performing unit which performs matching between the extracted matching data and the model data, and an obstacle detecting unit which detects the obstacle using the matching result.

According to still another aspect, there is provided a method of detecting an obstacle, including extracting at least one plane from measured range data for an obstacle, detecting at least one intersection point and at least one intersection line using the at least one plane, extracting matching data neighboring the at least one intersection point and the at least one intersection line from the range data, matching the extracted matching data with predetermined model data, and detecting the obstacle using the matching result.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram of an obstacle detecting apparatus according to an exemplary embodiment;

FIG. 2 is an illustration showing how to measure range data according to an exemplary embodiment;

FIG. 3 is an illustration for showing a plane extraction method according to an exemplary embodiment;

FIG. 4 is a flowchart of a method of improving plane accuracy according to an exemplary embodiment;

FIG. 5 is a flowchart of a method of extracting an intersection point and an intersection line according to an exemplary embodiment;

FIGS. 6A and 6B are illustrations for explaining a method of extracting matching data according to an exemplary embodiment; and

FIG. 7 is illustration showing how an obstacle is detected according to an exemplary embodiment.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

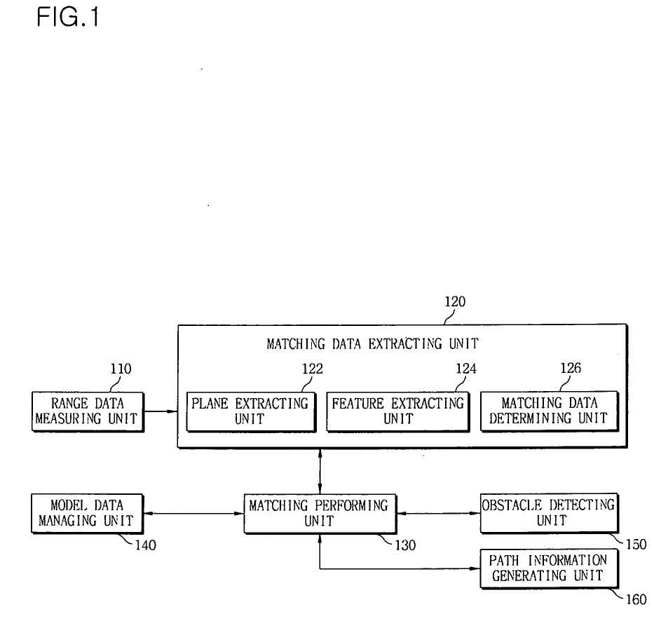

FIG. 1 is a block diagram of an obstacle detecting apparatus 100 according to an exemplary embodiment. Referring to FIG. 1, the obstacle detecting apparatus 100 reduces matching data acting as input data to a matching algorithm so as to shorten a period of time to perform matching while improving matching performance. To this end, the obstacle detecting apparatus 100 includes a range data measuring unit 110, a matching data extracting unit 120, a matching performing unit 130, a model data managing unit 140, an obstacle detecting unit 150, and a path information generating unit 160.

The range data measuring unit 110 scans a three dimensional (3D) environment and processes data obtained by the scanning to measure range data with respect to the 3D environment. The range data measuring unit 110 may include a sensor system using laser structured light for recognizing a 3D environment to sense and measure range data.

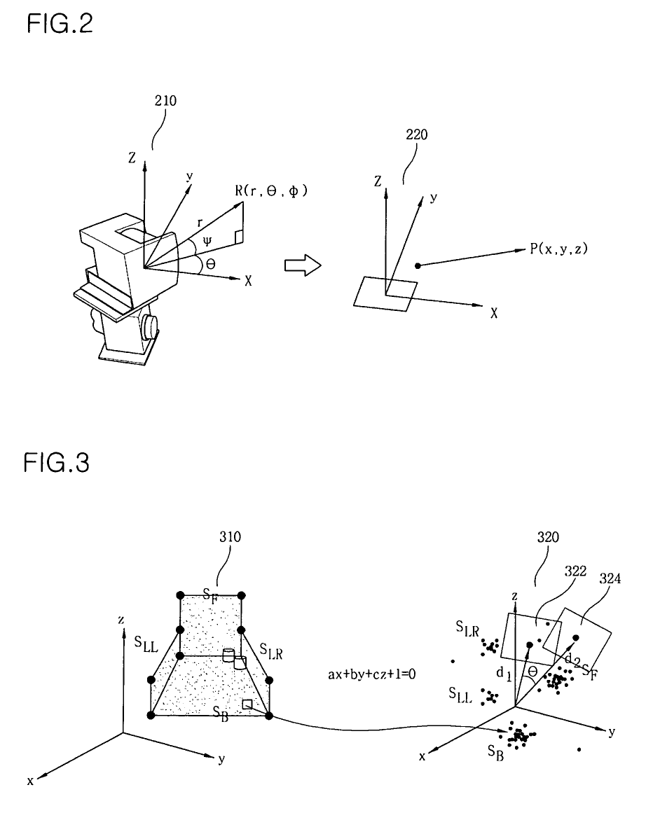

The range data may be measured in such a manner as shown in FIG. 2. FIG. 2 is an illustration showing how to measure range data according to an exemplary embodiment.

As shown in FIG. 2 with a numeral reference 210, the range data measuring unit 110 includes a 3D range sensor (not shown) to obtain 3D range information R[r, θ, ψ]. As shown by an illustration denoted by 220, the 3D range information R[r, θ, ψ] may be converted into a 3D point cloud which is represented by P[x, y, z]. Here, x has a value of r*cos ψ*cos θ, y has a value of r*cos ψ*sin θ, and z has a value of r*sin ψ.

Referring to FIG. 1 again, the model data managing unit 140 stores and manages model data (or CAD data) for representing a 3D environment. The model data managing unit 140 loads model data and the matching performing unit 130 extracts model data to be matched to the matching data.

The matching data extracting unit 120 extracts the matching data, which will be matched to the model data loaded by the model data managing unit 140 in the matching performing unit 130. According to the present exemplary embodiment, the matching data extracting unit 120 extracts at least one plane from the measured range data, extracts at least one intersection point and at least one intersection line by use of the extracted plane, and extracts pieces of range data neighboring the extracted at least one intersection point and at least one intersection line as matching data. In addition, when extracting the matching data, the matching data extracting unit 120 may establish a 3D space area including intersection points and intersection lines by considering uncertainties of intersection points and intersection lines which have been extracted as features, and then extracts range data included in the established space area as the matching data.

Referring to FIG. 1, the matching data extracting unit 120 includes a plane extracting unit 122, a feature extracting unit 124, and a matching data determining unit 126.

The plane extracting unit 122 extracts at least one plane from the measured range data. Additionally, the plane extracting unit 122 may perform operations for improving the accuracy in extracting the plane. To this end, the plane extracting unit 122 extracts at least one plane by use of the measured range data, groups together the measured range data based on a plane for which the measured range data is used, and thus it is possible to extract the plane more accurately based on respective distances between the grouped range data and each corresponding plane.

More specifically, the plane extracting unit 122 may extract individual planes more accurately in a manner that will be described below. First, the plane extracting unit 122 measures respective distances between one plane and range data belonging to a range data group and used for generating the plane. The plane extracting unit 122 eliminates range data whose distance from the plane is greater than a threshold from the range data group to make a new range data group. When a range data group for extracting one plane includes range data with respect to points {a₁, a₂, . . . , a₃}, if location information of each point, that is, the distance between the range data and the plane, is greater than a predetermined threshold, the point is eliminated from the corresponding range data group.

Then, the plane extracting unit 122 extracts a new plane by use of range data included in the new range data group. In a predetermined range data group, range data which is a great distance from the plane is highly likely to be noise, and thus it is eliminated from the range data group, and the remaining pieces of range data are used for extracting a more accurate plane.

According to the present exemplary embodiment, the plane extracting unit 122 may repeat operations for improving the plane accuracy until an error between the current plane and a new plane reaches below a predetermined error threshold. When a plane equation before the operation for improving the plane accuracy is ax+by+cz=1 and a plane equation after the operation for improving the plane accuracy is a_{new}x+b_{new}y+c_{new}z=1, an error between planes may be calculated by the square error method as described below:

Error=((a−a_{new})²+(b−b_{new})²+(c−c_{new})²)²

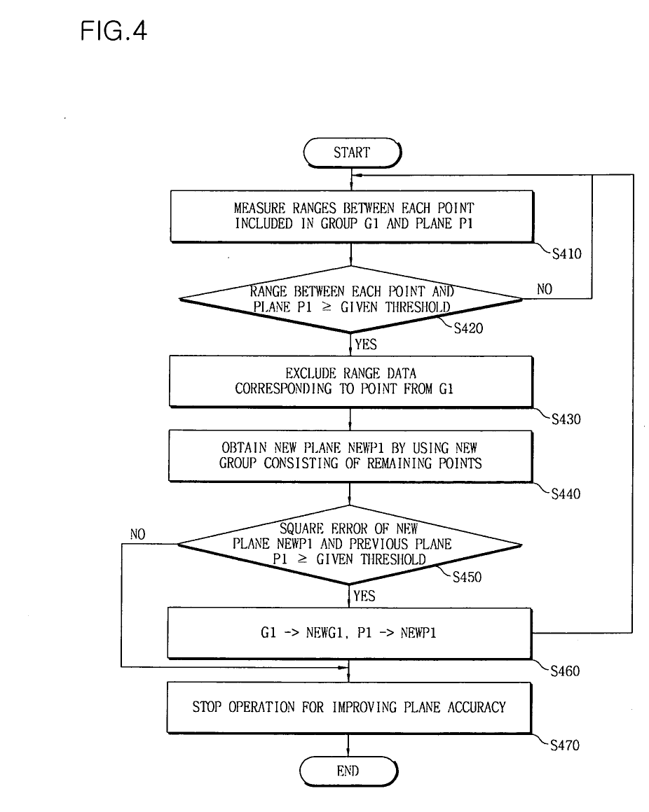

Furthermore, the plane extracting unit 122 may stop repeatedly performing the operations for improving the plane accuracy when reaching the predetermined number of times to perform the operations. A method of improving the plane accuracy will be described later in detail with reference to FIG. 4.

The feature extracting unit 124 detects features, which are at least one intersection point and at least one intersection line by use of at least one plane extracted by the plane extracting unit 122. According to the present exemplary embodiment, the measurement extracting unit 124 may detect, as an intersection point, a point where at least three planes are meeting together. However, in this case, since intersection points generated out of a detection area are meaningless, the feature extracting unit 124 eliminates the intersection points located out of the detection area. Moreover, the feature extracting unit 124 may extract a line where at least two planes are meeting each other.

The matching data determining unit 126 determines matching data based on the at least one extracted intersection point and at least one intersection line. The matching data refers to data to be matched to model data, from among the range data. The matching data determining unit 126 extracts matching data that is neighboring at least one intersection point and at least one intersection line, and transfers the extracted matching data to the matching performing unit 130.

The matching data determining unit 126 may extract the matching data neighboring at least one intersection point and at least one intersection line in such a manner as described below. The matching data determining unit 126 may determine matching data neighboring the intersection point by establishing a sphere-space having at least one intersection point as the center of the sphere and determining the range data included in the sphere-space as the matching data. Moreover, the matching data determining unit 126 may determine matching data neighboring an intersection line by establishing a 3D conic space around the intersection line and determining range data included in the conic space as matching data. In this case, a circular cross-sectional surface of the conic space may be established to gradually increase as it becomes farther from the at least one intersection point.

For example, the 3D conic space may look like a cone which has the intersection point as an apex and the intersection line as a circle axis and has a portion around the apex being cut off. In alternative, when conic spaces are generated to have each range data included in the sphere as the apex and have a circle axis parallel to the intersection line, the matching data determining unit 126 may extract the range data included in the generated conic space as matching data neighboring the intersection line.

Moreover, when the matching data determining unit 126 extracts matching data neighboring an intersection point and an intersection line, the volume of the sphere-space or the conic space is established to increase with the increase of an extraction error of the extracted intersection point or intersection line. Then, range data included in the established space may be extracted as matching data.

If an intersection point where three planes meet is referred to as a first intersection point, the uncertainty of the other intersection point (hereinafter, referred to as a second intersection point) is greater than that of the first intersection point. For example, the second intersection point may be a point where a given plane meets an intersection line to which the first intersection point is belonging. Therefore, according to the exemplary embodiment, in the case of the second intersection point, the matching data determining unit 126 establishes a sphere-space greater than the sphere-space for extracting matching data neighboring the first intersection point, and extracts range data as matching data from the established sphere-space. For example, a sphere-space with the diameter P which is greater than the diameter M from the first intersection point as the center of the sphere is established to extract range data included in the sphere as matching data neighboring the second intersection point.

Furthermore, when there is an extracted interaction line including not the first intersection point but the second intersection point, the matching data extracting unit 120 may determine that an uncertainty of the extracted intersection line is greater than an uncertainty of the intersection line including the first intersection point. Thus, the matching data extracting unit 120 establishes a conic space which has a gradient that makes the cross-sectional surface increase farther from the second intersection point and is greater than a gradient that makes the cross-sectional surface increase as farther from the first intersection point.

The matching performing unit 130 executes matching between the extracted range data and model data. The matching performing unit 130 may employ various methods using an interactive closest point (ICP), a neuron network, or an evolutionary computation, to execute matching between the extracted range data and the model data.

The obstacle detecting unit 150 detects an obstacle based on the matching execution result. The obstacle detecting unit 150 detects an obstacle using range data remaining after matching measured range data with the model data by the matching performing unit 13. For example, if distances between pieces of the remaining range data are within a given threshold, these range data are determined as data for the same obstacle. When, if the number of range data determined as indicating the same obstacle is smaller than a given number, for example, five, the pieces of range data are considered to be noise, and otherwise, if the number is greater than the given number, the range data are determined as indicating the same obstacle. A method of detecting an obstacle may be modified and implemented in various ways.

The path information generating unit 160 creates a moving path or a welding path of a robot based on information of the detected obstacle. The obstacle detecting apparatus 100 may further include an information providing unit (not shown) which outputs and displays the generated path information for a user.

FIG. 3 is an illustration for showing a plane extraction method according to an exemplary embodiment. Referring to FIG. 3, if there are at least three pieces of spatially neighboring 3D range data, a least square method may be used to extract a plane.

For example, by using n points and the least square method, plane equation like Equation 2 is obtained.

$${ax}_{1} + {by}_{1} + {cz}_{1} = 1 \\ {ax}_{2} + {by}_{2} + {cz}_{2} = 1 \\ \begin{matrix} & ⋮ & ⋮ & ⋮ & \end{matrix} \\ {ax}_{n} + {by}_{n} + {cz}_{n} = 1 \\ [ \begin{matrix}{x}_{1} & {y}_{1} & {z}_{1} \\ {x}_{2} & {y}_{2} & {z}_{2} \\ ⋮ & ⋮ & ⋮ \\ {x}_{n} & {y}_{n} & {z}_{n}\end{matrix} ] [ \begin{matrix}a \\ b \\ c\end{matrix} ] = [ \begin{matrix}1 \\ 1 \\ ⋮ \\ 1\end{matrix} ] \\ AX = B \\ X = {( {A}^{T} A )}^{- 1} AB \qquad Equation 2$$

Difference in distances from the origin point each of several planes extracted by using Equation 2 and angles between planes are calculated, and the planes within a given range can be grouped. For example, planes that are within three degrees with respect to the origin point may be grouped together, or planes spaced less than three centimeters may be grouped together.

An angle θ and a distance |d₁−d₂| between a plane 322 represented by ax₁+by₁+cz₁=1 and a plane 324 represented by ax₂+by₂+cz₂=1 are calculated as follows:

$$\vert {d}_{1} - {d}_{2} \vert = \vert \frac{1}{\sqrt{{a}_{1}^{2} + {b}_{1}^{2} + {c}_{1}^{2}}} - \frac{1}{\sqrt{{a}_{1}^{2} + {b}_{2}^{2} + {c}_{2}^{2}}} \vert \\ θ = {cos}^{- 1} ( {n}_{x 1} {n}_{n 2} + {n}_{y 1} {n}_{y 2} + {n}_{y 1} {n}_{y 2} ) \\ d = \vert \frac{1}{\sqrt{{a}^{2} + {b}^{2} + {c}^{2}}} \vert , \\ Here , \\ {n}_{x} = \vert \frac{a}{\sqrt{{a}^{2} + {b}^{2} + {c}^{2}}} \vert , \\ {n}_{y} = \vert \frac{b}{\sqrt{{a}^{2} + {b}^{2} + {c}^{2}}} \vert , \\ {n}_{z} = \vert \frac{c}{\sqrt{{a}^{2} + {b}^{2} + {c}^{2}}} \vert \qquad Equation 3$$

Here, ‘d’ represents a distance between the origin point and one piece of range data, and nₓ, n_{y}, and n_{z} represent plane coefficients or normal vectors.

According to the exemplary embodiment, by use of the grouped planes, a plane can be extracted. For example, a plane equation may be created from the average of the grouped planes, and a plane may be obtained from the created plane equation.

FIG. 4 is a flowchart of a method of improving plane accuracy according to an exemplary embodiment.

It is assumed that a group of all range data of points used for generating a plane P1, which is represented by ax₁+by₁+cz₁=1, is G1. Distances between each range data included in the range data group G1 and the plane P1 are measured (operation S410). A measured distance between a certain point and the plane P1 is greater than a specific threshold, for example, 1.5 cm (operation S420), the range data corresponding to the point is excluded from group G1 (operation S430). In this manner, points having a distance from the plane P1 greater than the threshold are eliminated from the group G1, the remaining points are grouped into a new group newG1 and then a least square method is executed on the new group newG1 to obtain a new plane newP1 (operation S440).

A squared error between the new plane newP1 and the original plane P1 is obtained, and if the squared error is greater than a specific threshold, for example, 0.001 (operation S450), the previous group G1 is changed into the new group newG1, and the plane P1 is changed into the new plane newP1 (operation S460). Subsequently, operations S410 through S450 are repeated. Such repetition is a learning process to narrow the range data for extracting the accurate plane.

When an error of operation S450, after repeatedly executing operations S410 to S450, is smaller than a particular threshold, the procedure for improving plane accuracy can be stopped (operation S470) without returning to operation S410. In the course of stopping the plane accuracy improvement, when the number of range data of the new group newG1 is reduced less than a half of the number of range data in the original group G1, the original group G1 and the original plane P1 can be used intact. This is because the plane accuracy improvement is pointless unless more than half of pieces of range data of the points are used for improving the plane accuracy to extract an accurate plane. The plane accuracy improvement may be performed on each extracted plane.

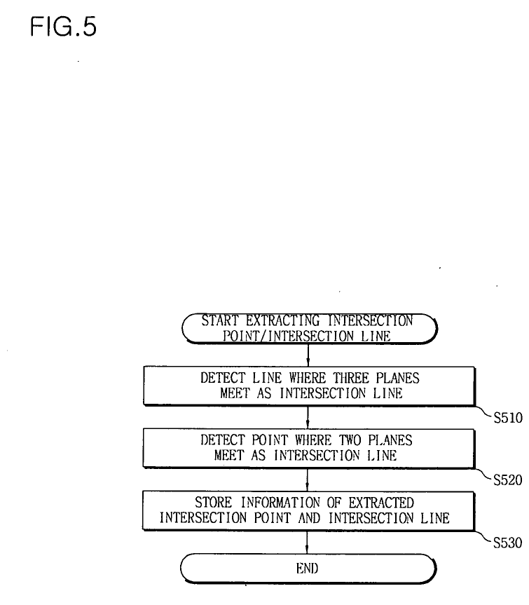

FIG. 5 is a flowchart of a method of extracting an intersection point and an intersection line according to an exemplary embodiment.

When the plane equation is obtained as shown in FIG. 4, an intersection point where three planes are meeting together is detected (operation S510). By using three plane equations, an intersection point where the three planes are meeting can be calculated. At this time, intersection points located out of a detecting area of an obstacle detecting apparatus are excluded from detected intersection points.

Also, an intersection line is detected where two planes are meeting (operation S520). Information of the detected intersection point and the detected intersection line are stored (operation S530).

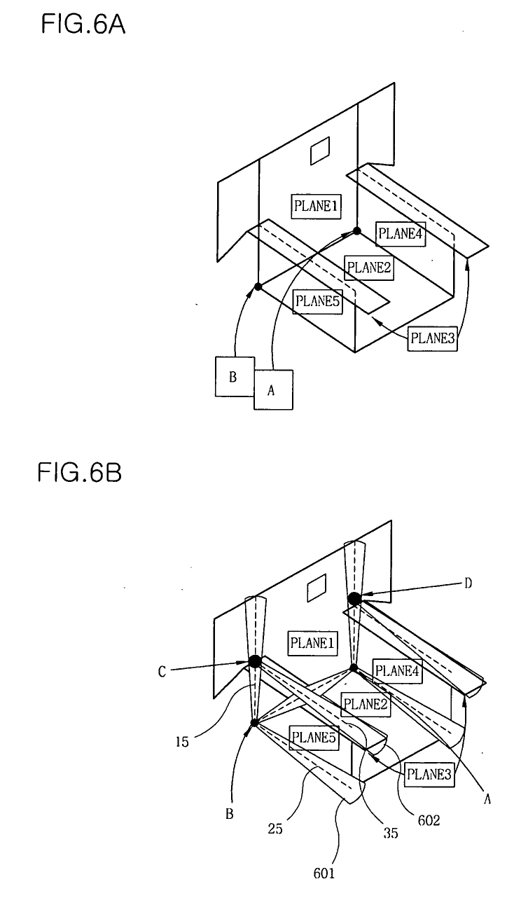

FIGS. 6A and 6B are illustrations for explaining a method of extracting matching data according to an exemplary embodiment. It is assumed that planes 1 through 5, intersection points A and B and intersection lines are detected as shown in FIG. 6A.

Referring to FIG. 6B, the feature extracting unit 124 extracts the intersection point A where the plane 1, the plane 2 (bottom plane) and the plane 4 are meeting together, and the intersection point B where the plane 1, the plane 2 and plane 5 are meeting together. Moreover, equations of five lines are obtained by using intersection lines where the planes meet based on the coordinates of extracted intersection points A and B.

According to the exemplary embodiment, the matching data determining unit 126 determines matching data in consideration of uncertainties of the extracted intersection points and lines, that is, the uncertainties of the features. When the matching data is located next to the intersection point and sphere-spaces are established on the basis of at least one intersection point, range data included in each sphere-space may be extracted as matching data.

For example, matching data placed neighboring the intersection point A or B includes all range data included in a sphere having the intersection point A or B as the center of the sphere and having a diameter M.

Furthermore, the matching data determining unit 126 establishes a 3D conic space around each intersection line, and range data included in the established conic space may be extracted as matching data neighboring the intersection line. Here, the conic space may have a fan-shaped cross-section like 601 or 602 in FIG. 6B which becomes wider outward from the center, that is, the intersection point. Referring to FIG. 6B, there is established a conic space which has the intersection point B as an apex and a circle axis parallel to an intersection line 25 where the plane 2 meets the plane 5 and an angle N between the circle axis including the intersection point and a generating line of the conic space is N, and range data included in the conic space may be extracted as matching data.

In the case of a longitudinal line 35 which meets an intersection line 15 including the intersection point B, a sphere having a diameter P greater than M and as the center the intersection point C where the longitudinal line 35 and the intersection line 15 are meeting is set, and range data included in the established sphere is extracted as matching data neighboring the intersection point C. This is because the uncertainty of the intersection point C is higher than that of the intersection point A or the intersection point B.

In addition, the matching data determining unit 126 establishes conic spaces each of which has an apex that is range data included in the sphere having a diameter P, and then extracts range data included in the established conic spaces as range data neighboring the longitudinal line 35. Also, when the matching data determining unit 126 determines that the uncertainty of the intersection line 35, that is, the longitudinal line, is greater than the uncertainty of the extracted intersection line 25 and then establishes a conic space including the intersection line 35, the matching data determining unit 126 may establish the conic space including the intersection line 35 to have a gradient greater than that of a conic space including the intersection line 25. The gradient allows a size of circular cross-sectional surface of the conic space to increase as farther from the intersection point C or B.

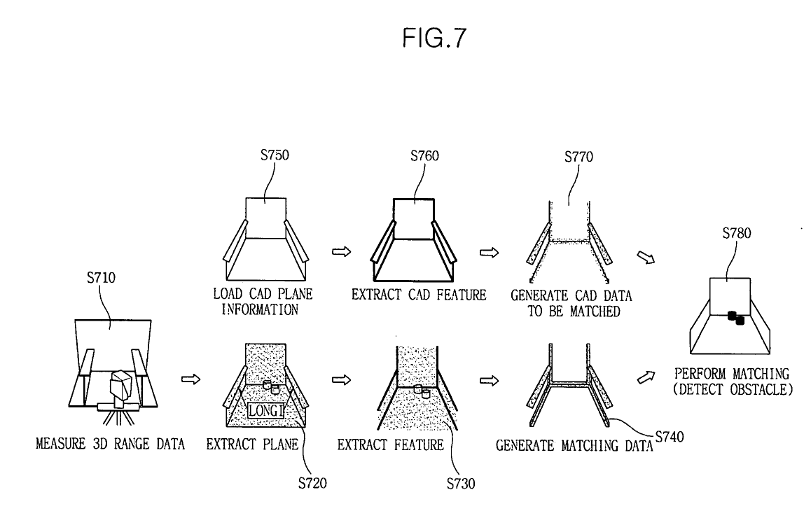

FIG. 7 is an illustration showing how an obstacle is detected according to an exemplary embodiment. An obstacle detecting apparatus 100 measures 3D range data (operation S710). The obstacle detecting apparatus 100 extracts planes using the measured range data (operation S720), and extracts intersection points and intersection line as features (operation S730). Subsequently, the obstacle detecting apparatus 100 extracts matching data from the range data (operation S740). The matching data is data to be used for matching to predetermined model data and is placed neighboring at least one intersection point and at least one intersection line.

During extraction of the matching data (operation S740), a three dimensional area is established including corresponding intersection point and intersection line based on uncertainties of each of the detected intersection points and intersection lines, and then range data included in the established 3D area may be extracted as matching data. In addition, according to an exemplary embodiment, in the course of extracting matching data (operation S740), a sphere-shaped or a conic space is established such that a volume of the space increases with the significance of extraction errors of the intersection point and the intersection line. Then range data in the sphere-shaped or the conic space may be extracted as matching data neighboring the intersection point or the intersection line.

The obstacle detecting apparatus 100 loads CAD plane information as the predetermined model data to be matched to the matching data (operation S750), information on a CAD intersection point and a CAD intersection line is detected (operation S760), and then CAD data for matching is generated (operation S770).

The obstacle detecting apparatus 100 performs matching by use of the matching data extracted in operation S740 and the CAD data for matching generated in operation S770, and then is enabled to detect an obstacle based on the matching result (operation S780).

According to an exemplary embodiment, matching data is extracted by reflecting uncertainties of an intersection point and an intersection line which are extracted from measured range data, and matching is performed based on the matching data. Thus, the time for performing matching is reduced, and accurate matching can be achieved. Therefore, if an obstacle detecting apparatus in accordance with the exemplary embodiment is applied to a welding robot, the welding robot may spend less periods of time to process range data to move or weld while avoiding obstacles and may perform more accurate obstacle detection.

The above-mentioned method according to the present embodiment of the invention may be implemented by computer readable code stored in any form of recording media, such as CD-ROM, RAM, ROM, floppy disk, hard disk, or magneto-optical disk, or in any computer-readable form, such as computer code organized into executable programs.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents.

Thus, although a few embodiments have been shown and described, it would be appreciated by those skilled in the art that changes may be made in these embodiments without departing from the principles and spirit of the invention, the scope of which is defined in the claims and their equivalents.

What is claimed is:

1. An obstacle detecting apparatus comprising:
a model data managing unit which stores and manages model data representing a three dimensional (3D) environment;
a range data measuring unit which measures range data for an obstacle;
a matching data extracting unit which extracts at least one plane based on the measured range data, extracts at least one intersection point and at least one intersection line by use of the at least one plane, and extracts matching data neighboring the at least one intersection point and at least one intersection line;
a matching performing unit which performs matching between the extracted matching data and the model data; and
an obstacle detecting unit which detects the obstacle using the matching result.

2. The obstacle detecting apparatus of claim 1, wherein the matching data extracting unit establishes three dimensional areas with respect to each intersection point and intersection line to include the corresponding intersection point and intersection line based on uncertainties of the extracted intersection point and intersection line and extracts range data included in the established area as the matching data.

3. The obstacle detecting apparatus of claim 1, wherein the matching data extracting unit groups portions of the measured range data that is used for generating each plane, and performs a plane accuracy improvement process to extract a respective plane, with greater accuracy than the extracted at least one plane, based on respective distances between corresponding grouped range data and each corresponding plane.

4. The obstacle detecting apparatus of claim 3, wherein when extracting a plane with the greater accurately, the matching data extracting unit measures the respective distances between each range data included in the grouped range data and the plane, generates a new range data group by eliminating range data that has a distance from the plane greater than a specific threshold from the range data group, and extracts a new plane by using range data included in the new range data group.

5. The obstacle detecting apparatus of claim 3, wherein the plane extracting unit repeatedly performs the plane accuracy improvement process until an error between the plane and respective new planes is less than a predetermined threshold error.

6. The obstacle detecting apparatus of claim 3, wherein the matching data extracting unit stops performing the plane accuracy improvement process when a number of repeated performances of the plane accuracy improvement process reaches a predetermined threshold number.

7. The obstacle detecting apparatus of claim 1, wherein the matching data extracting unit extracts a point where at least three planes are meeting as an intersection point and extracts a line where at least two planes are meeting as an intersection line.

8. The obstacle detecting apparatus of claim 1, wherein the matching data extracting unit establishes sphere-spaces, each of which has each of at least one intersection point as a center, extracts range data included in a respective sphere-space as matching data neighboring the range data, establishes a respective three dimensional conic space around each of at least one intersection line, extracts range data included in the respective established conic space as matching data neighboring the intersection line, with each respective conic space having a cross sectional surface of which an area becomes gradually greater farther from the intersection point.

9. The obstacle detecting apparatus of claim 8, wherein when the matching data extracting unit extracts matching data neighboring the intersection point or the intersection line, the matching data extracting unit establishes the respective sphere-space or the respective conic space such that a volume of the respective space increases as extraction error of the extracted intersection point or the extracted intersection line becomes greater.

10. The obstacle detecting apparatus of claim 9, wherein the matching data extracting unit determines whether an extraction error of an intersection point, where at least two or more planes and one intersection line meet, is greater than an extraction error of an intersection point, where at least three or more planes meet, and whether an extraction error of an intersection line including no intersection point, where the at least three or more planes meet, is greater than an extraction error of an intersection line including the intersection point, where the at least three or more planes meet.

11. The obstacle detecting apparatus of claim 10, wherein a greater the extraction error is determined, by the matching data extracting unit, a greater a gradient of the respective conic space is set by the matching data extracting unit, with the gradient making a circular cross-sectional surface of the conic space gradually increasing farther from the at least one intersection point.

12. The obstacle detecting apparatus of claim 1, further comprising:
at least one of:
a path information generating unit which creates at least one of a moving path and a welding path of a robot by use of information of the detected obstacle; and
an information providing unit which provides a user with information of the detected obstacle.

13. A method of detecting an obstacle, comprising:
extracting at least one plane from measured range data for an obstacle;
detecting at least one intersection point and at least one intersection line using the at least one plane;
extracting matching data neighboring the at least one intersection point and the at least one intersection line from the range data;
matching the extracted matching data with predetermined model data; and
detecting the obstacle using the matching result.

14. The method of claim 13, wherein, based on uncertainties of the detected intersection point and the detected intersection line, a three dimensional space is established for each of the intersection point and the intersection line to be included in the space, and range data included in the established space is extracted as the matching data.

15. The method of claim 13, wherein the extracting of the at least one plane includes generating at least one plane using the measured range data, grouping the measured range data used for generating a same plane into same range data groups, and improving an accuracy of each plane based on respective distances between grouped range data and each plane.

16. The method of claim 15, wherein the improving of the accuracy of a respective plane includes measuring distances between each range data included in a range data group and a corresponding plane, determining a new range data group by eliminating range data having respective measured distances greater than a threshold from the range data group, and extracting a new plane using range data included in the new range data group.

17. The method of claim 13, wherein, in the detecting of the at least one intersection point and the at least one intersection line, a point where at least three planes meet is determined to be the intersection point and the intersection line is determined to include a point where at least two planes meet.

18. The method of claim 13, wherein, in the extracting of the matching data, when respective sphere-spaces are established around each at least one intersection point, as a center, range data included in respective sphere-spaces, as matching data neighboring the intersection point, and respective three dimensional conic spaces are established around each at least one intersection line, range data included in the respective conic spaces is extracted as matching data neighboring the at least one intersection line, and an area of a cross-sectional surface of the conic space increases farther from the at least one intersection point.

19. The method of claim 18, wherein, in the extracting of the matching data, the respective sphere-spaces or the respective conic spaces are established such that a volume of each space increases as an extraction error of respective extracted intersection points or respective extracted intersection lines increase when the matching data is extracted neighboring the respective intersection point or the respective intersection line.

20. The method of claim 13, further comprising:
at least one of:
generating at least one of a moving path or a welding path of a robot using information of the detected obstacle; and
providing a user with information of the extracted obstacle.
